(19) United States
(12) Patent Application Publication
(10) Pub. No.: US 2008/0120726 A1
(43) Pub. Date: May 22, 2008

(54) External storage device

(75) Inventors: Takashi Tsunehiro, Ebina (JP); Hiromi Isokawa, Sagamihara (JP); Tomihisa Hatano, Yokohama (JP); Takatoshi Kato, Yokohama (JP)

Correspondence Address: MCDERMOTT WILL & EMERY LLP, 600 13TH STREET, N.W., WASHINGTON, DC, 20005-3096, US

(73) Assignee: HITACHI LTD.

(21) Appl. No.: 11/905,226

(22) Filed: Sep. 28, 2007

(30) Foreign Application Priority Data
Nov. 20, 2006 (JP) 2006-312361

(51) Int. Cl. G06F 7/04

(52) U.S. Cl. 726/27

(57) ABSTRACT

To provide a mechanism for preventing information leakage by erasing stored information if a preset condition is not satisfied, because if an external storage device in which the information is stored is stolen or lost the risk of information leakage through decryption still remains even in the case where the information is encrypted. An external storage device has a locking management function capable of setting available conditions for stored information and controlling permission/prohibition of user access depending on whether the conditions are satisfied. User access is permitted if the available conditions are satisfied. The stored information is erased if the available conditions are not satisfied.

### INCORPORATION BY REFERENCE

This application claims priority based on a Japanese patent application, No. 2006-312361 filed on Nov. 20, 2006, the entire contents of which are incorporated herein by reference.

### BACKGROUND OF THE INVENTION

The present invention relates to a technique for safely carrying information that is stored in an external storage device such as a memory card. More particularly, the invention relates to a technique for preventing information leakage by managing information stored in an external storage device in such a manner that it can be used under a particular condition.

In recent years, with the price reduction of personal computers (hereinafter abbreviated as PCs) and network equipment, a number of companies have come to distribute business terminals such as PCs to employees and let them work using those terminals. As PC prices decrease and more PCs come to be used, chances of leakage of highly secret information and like information in a company increase. As a countermeasure, for example, dedicated terminals not having a mechanism of storing information have been conceived. Information leakage due to loss of a terminal can be prevented by performing business processing while receiving image information by remotely manipulating a server installed in a company via a communication line with the use of the terminals. However, since this method is based on securing of a communication line, a mechanism which allows safe carrying of information and is free of risk of information leakage is desired in the case where no communication line can be secured.

On the other hand, in recent years, IC cards (also called smart cards) incorporating a processor (central processing unit, CPU) called an IC chip have come to attract much attention as devices having an authentication function. Since IC cards have a computation function themselves, when receiving a read or write instruction from a host, they can judge, by themselves, whether the access is legitimate. Furthermore, incorporating a rewritable memory such as an EEPROM or a RAM, IC cards can store an application or information of a user or a card issuer.

An IC card can authenticate a user or output information for denial prevention by performing a computation on externally input information using information (a secret key or the like) that exists only in the legitimate card. Therefore, an IC card can perform a control as to whether or not to output, to a reader/writer or a host, information stored in the IC card by collating user-input personal identification information with identification information held inside the card.

Since CPUs cards themselves are difficult to forge, it is also difficult to falsify information issued by an IC card module (IC card chip) which is an anti-tampering device or to illegally access information stored in an IC card module. As such, IC cards make it possible to construct a system which is high in the security level.

On the other hand, flash memory cards are known as memory cards which incorporate a large-capacity, nonvolatile memory module and allows rewriting of information held inside. Many flash memory cards are not provided with hardware resistance to an attack from a third party (i.e., tampering resistance). A non-tampering-resistant flash memory card is associated with not a low risk that when stolen or lost it is disassembled and information held therein leaks to a third party through analysis of its memory or controller.

As described in Japanese Patent Laid-open Publication No. 2001-209773, a flash memory card having a flash memory interface and an IC card function is known. Because of its large storage capacity, this flash memory card having a flash memory interface and an IC card function is convenient to store, in the card, for carrying, a user's documents, system setting files, or the like originally stored in a personal computer or a workstation.

### SUMMARY OF THE INVENTION

In the above-described dedicated terminals such as PCs in which no information can be stored, the securing of a communication channel is indispensable and no work can be done unless a communication channel is secured. When such a situation is expected, it is necessary to store, for carrying, necessary information in a certain external storage device and do work using the information stored in the external storage device. In the event of such a situation, sufficient care should be taken so as not to lose the external storage device. It is common practice to encrypt information in storing it in the external storage device. However, even if information is encrypted, it may still leak through decryption. A mechanism for preventing information leakage at a high probability is thus desired.

The present invention provides a mechanism for erasing information stored in an external storage device and thereby disabling access to it when it comes not to satisfy a preset available condition.

Other objects and novel features of the invention will become apparent from the description of the specification and the accompanying drawings.

Typical aspects of the invention will be outlined below.

An external storage device according to the invention is provided with a nonvolatile storage element which is a medium for storing information (called storage information) and a control section for connecting the medium to a terminal or a PC. The nonvolatile storage element is configured so as to have a locking management function capable of prohibiting access from a user and to thereby allow setting of a use condition (available condition) for information stored in the nonvolatile storage element.

The external storage device is further characterized in that access from a user is permitted if the use condition is satisfied and stored information is erased if the use condition is not satisfied. No limitations are imposed on the content of “information” as a subject of access provided that it should be digital information; it may be a program or data as a subject of processing of a PC.

More specifically, one aspect of the invention provides an external storage device access system having an external storage device and a terminal apparatus, characterized in that the external storage device comprises a storage element in which an access-controlled area is set which is access-controlled on the basis of authentication information and a control section for access-controlling the storage element; and that the terminal apparatus comprises an input/output interface and an access management section for accessing the external storage device.

The external storage device access system further characterized in that when the external storage device is connected to the input/output interface, the control section is activated in such a state that it refuses access to the access-controlled area; upon detection of the connection of the external storage device to the input/output interface, the access management section of the terminal apparatus sends, to the control section, a request, including authentication information of a user of the terminal apparatus, for permission of user access to the access-controlled area; the control section of the external storage device performs verification of the user authentication information received from the terminal apparatus; if the verification succeeds, the control section sends, to the terminal apparatus, a notice of permission of user access to storage information that is stored in the access-controlled area; and if the verification fails, the control section erases the storage information stored in the access-controlled area.

The external storage device access system may be configured in such a manner that the control section sends a notice of the failure of the verification to the access management section of the terminal apparatus; that when receiving the notice of the failure of the verification, the access management section sends, to the control section, an instruction to erase the storage information stored in the access-controlled area; and that when receiving the instruction to erase the storage information, the control section erases the storage information stored in the access-controlled area.

The external storage device access system may also be configured in such a manner that the access-controlled area comprises one or more use-condition-accompanied areas for which use conditions are set, respectively; that each of the use-condition-accompanied areas comprises a management information area for storing the use condition and a data area for storing the storage information; that if the verification of the user authentication information succeeds, the control section makes a transition to a state that it permits reading of the use conditions stored in the management information areas and can permit access to the storage information stored in the data areas; that when receiving, from the control section, the user access permission notice which is sent in response to the user access permission request, the access management section of the terminal apparatus sends, to the control section, an instruction to read the use conditions stored in the management information areas of the one or more use-condition-accompanied areas, checks whether or not to permit user access to the individual use-condition-accompanied areas on the basis of the read-out use conditions received form the control section, sends, to the control section, an instruction to erase the storage information stored in the data area of a use-condition-accompanied area for which user access has been refused, and sends, to the user, after erasure of the storage information, a notice of permission of access to the storage information stored in the data area of a use-condition-accompanied area for which user access has been permitted; that when receiving the use conditions reading instruction from the access management section of the terminal apparatus, the control section of the external storage device reads the use conditions stored in the management information areas and sends them to the terminal apparatus; and that when receiving, from the access management section of the terminal apparatus, the instruction to erase the storage information stored in the data area of the use-condition-accompanied area for which user access has been refused, the control section erases the storage information.

Furthermore, the external storage device access system may be configured in such a manner that the external storage device further comprises a user authentication processing section for authenticating a user; that when the external storage device is connected to the input/output interface of the terminal apparatus and the terminal apparatus is activated, the access management section of the terminal apparatus stores input user authentication information and sends it to the user authentication processing section of the external storage device; that the user authentication processing section performs processing of authenticating the user using the received user authentication information and sends an authentication result to the access management section; that if the authentication result of the user authentication processing section indicates that the user is legitimate, the access management section uses the stored user authentication information as authentication information of the user of the terminal apparatus to be included in the request for permission of user access to the access-controlled area; and that if the authentication result indicates that the user is not legitimate, the access management section stops operation of the terminal apparatus.

According to the above forms of the invention, since the use condition is set in advance, the external storage device can be used as one that allows access to its internal information as long as the use condition is satisfied. If the use condition comes not to be satisfied any more, the information stored in the external storage device is erased and hence cannot be accessed. This mechanism can provide an external storage apparatus with which the risk of leakage of the information stored therein is very low even if it is lost.

### ADVANTAGE OF THE INVENTION

The invention makes it possible to provide an external storage device which is very low in the risk of information leakage.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 illustrates a connection form of an external storage device or a memory card and a terminal according to each embodiment of the invention.

FIG. 2 illustrates a functional configuration of the terminal according to the first embodiment.

FIG. 3 illustrates a first configuration of the memory card used in each embodiment.

FIG. 4 illustrates a second configuration of the memory card used in each embodiment.

FIG. 5 illustrates the structure of a nonvolatile storage area of the external storage device or the memory card according to the first embodiment and information to be stored in each management information area.

FIG. 6 illustrates commands used in each embodiment.

FIG. 7 illustrates a process flow (part 1) according to the first embodiment.

FIG. 8 illustrates a process flow (part 2) according to the first embodiment.

FIG. 9 illustrates an error handling flow according to the first embodiment.

FIG. 10 illustrates the structure of a nonvolatile storage area of an external storage device or a memory card according to a second embodiment.

FIG. 11 illustrates the functional configuration of a terminal according to the second embodiment.

FIG. 12 illustrates a process flow according to the second embodiment.

FIG. 13 illustrates a process flow according to the third embodiment.

FIG. 14 illustrates a process flow according to a fourth embodiment showing how a manager sets management information in advance.

### DETAILED DESCRIPTION OF THE EMBODIMENTS

Embodiments of the present invention will be hereinafter described in detail with reference to the accompanying drawings. The same reference numerals in the drawings denote components having the same function and hence they will not be described redundantly.

### First Embodiment

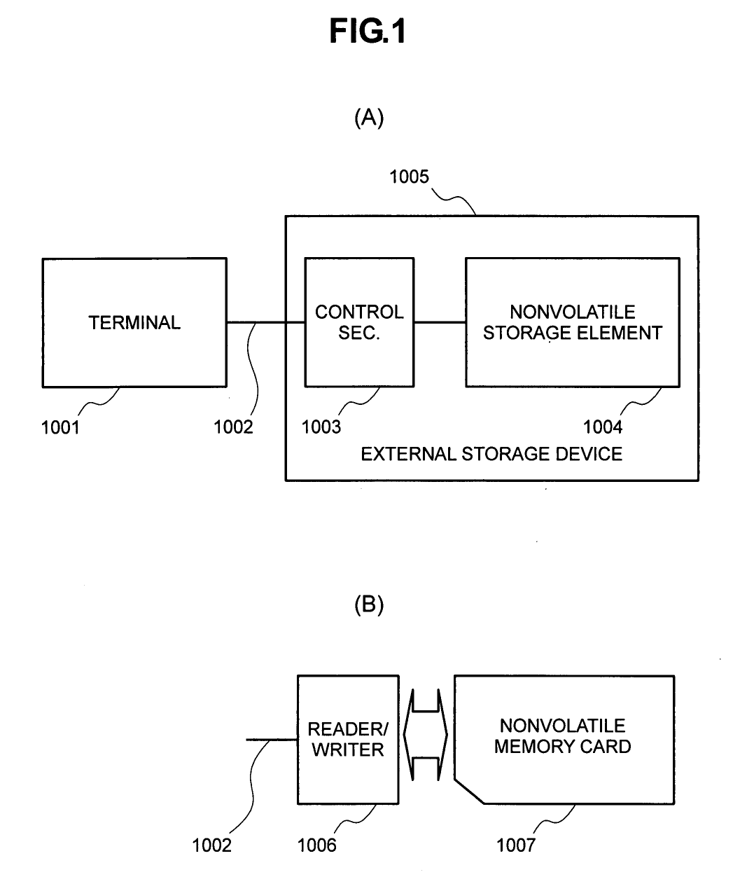

An external storage device according to a first embodiment of the invention will be described below with reference to FIGS. 1-10.

FIG. 1 shows a system configuration according to the first embodiment of the invention. An external storage device 1005 shown in FIG. 1(A) is composed of a control section 1003 and a nonvolatile storage element 1004, and is connected to a terminal apparatus (hereinafter referred to as “terminal”) 1001 via a general-purpose input/output bus 1002. FIG. 1(B) shows another external storage device 1005 which is composed of a nonvolatile memory card (hereinafter referred to as “memory card”) 1007 and a reader/writer 1006 which connects the memory card 1007 to a general-purpose input/output bus 1002. In this case, as described later, the functions of the control section 1003 are divided into functions of the memory card 1007 and those of the reader/writer 1006.

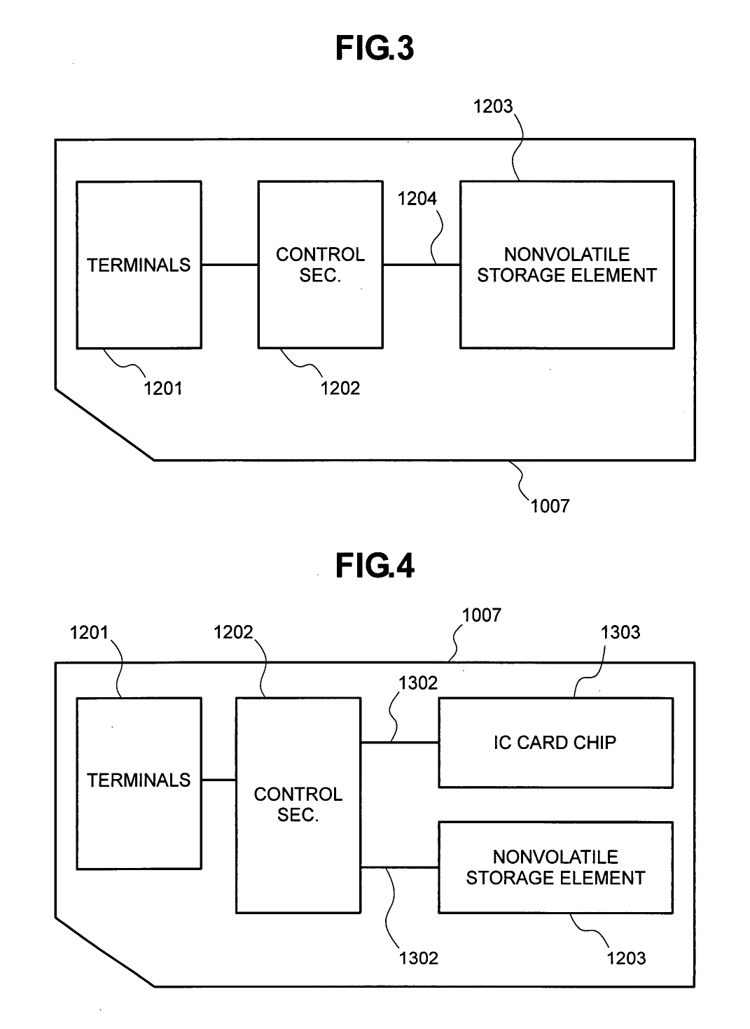

FIG. 3 shows an exemplary configuration of the memory card 1007. The memory card 1007 is composed of terminals 1201 for connection to the reader/writer 1006, a control section 1202, and a nonvolatile storage element 1203 for storing information (referred to as “storage information”). The nonvolatile storage element 1203 may have the same characteristics as the nonvolatile storage element 1004 shown in FIG. 1. The terminals 1201 may be a transmission/reception antenna for realizing a non-contact memory card.

FIG. 4 shows another exemplary configuration of the memory card 1007. This configuration is different from the configuration of FIG. 3 in being further provided with an IC card chip 1303 which is connected to the control section 1202 via a signal line 1301. With this configuration, the memory card 1007 of FIG. 4 also has a user authentication function which is provided by the IC card chip 1303. As described above, the control section 1202 shown in FIG. 3 has part of the functions of the control section 1003 shown in FIG. 1 and the reader/writer 1006 has the other part of the functions of the control section 1003 shown in FIG. 1.

The control section shown in each figure is composed of a CPU, a nonvolatile memory, and an input/output circuit which are connected to each other by an internal signal line such as a bus. Programs for realizing individual pieces of processing (described later) of the control section are stored in the nonvolatile memory. The pieces of processing of the control section are realized by “processes” which are implemented by the CPU's running those programs. However, the following description will be made as if the control section performed the individual pieces of processing on its own.

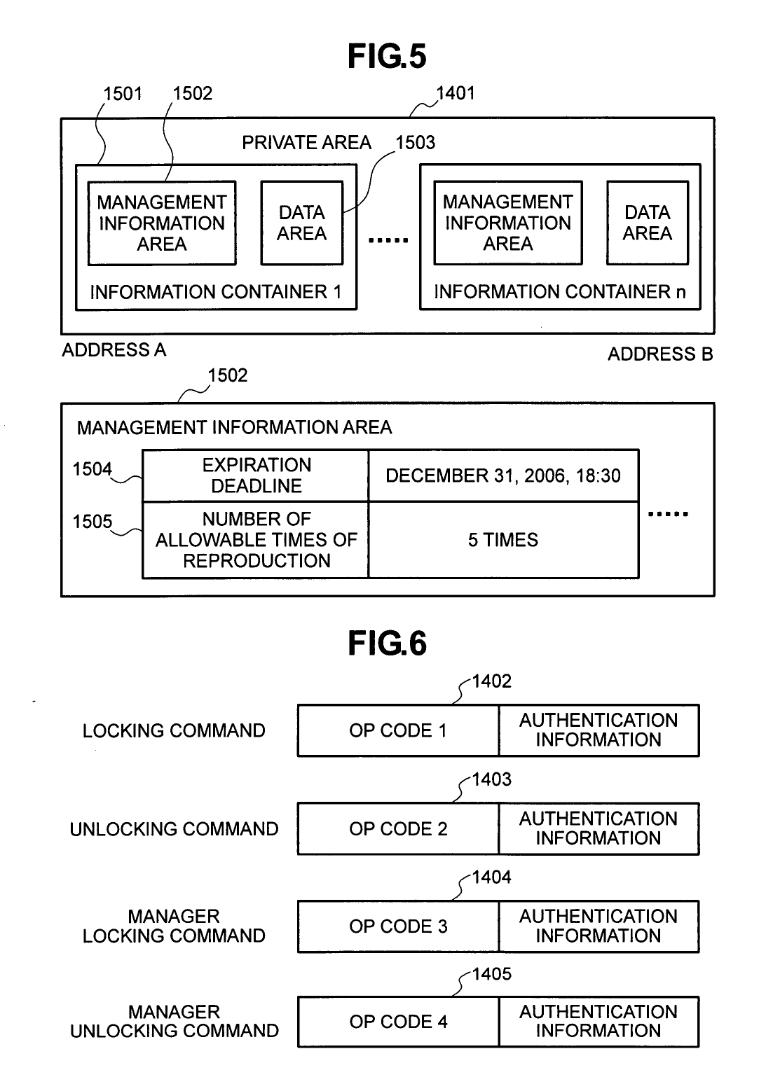

The nonvolatile storage element 1004 of the external storage device 1005 and the nonvolatile storage element 1203 of the memory card 1007 include an area called a private area 1041 (address A to address B; corresponds to an access-controlled area) which is access-controlled by the control section 1003 or 1202 which has received a command shown in FIG. 5. FIG. 6 illustrates commands.

For example, when supply of power to the external storage device 1005 or the memory card 1007 is started (e.g., when it is connected to the terminals 1001 or the reader/writer 1006) or when the external storage device 1005 or the memory card 1007 receives a locking command 1402 (corresponds to an access prohibition request) with authentication information or the like from the outside, the control section 1003 or 1202 thereafter prohibits external access to the information stored in the private area 1401. If the control section 1003 or 1202 receives an unlocking command 1403 (corresponds to an access permission request) with correct authentication information from the outside, executes it, and judges that the authentication information is legitimate through verification, the control section 1003 or 1202 enables access. Information that is necessary for verification maybe stored in the control section 1003 or 1202.

To enable handling of the storage information even when a user forgets his or her authentication information or the authentication information becomes unknown because of, for example, retirement of a user, it is desirable that a manager locking command 1404 and a manager unlocking command 1405 be set in the private area 1401. If the system is configured in such a manner that these commands require authentication information, illegal access by a non-legitimate manager can be prevented.

With the above configuration, if the external storage device 1005 or the memory card 1007 receives a locking command 1402, it is removed from the general-purpose input/output bus 1002 or the reader/writer 1006, or the supply of power to it is terminated when it is in an access-enabled state as a result of execution of an unlocking command 1403, an access-enabled state is not restored and, instead, a locked state (access-prohibited state) is established (even if it is connected again to the general-purpose input/output bus 1002 or the reader/writer 1006 or power supply is resumed). A higher level of safety is thus realized.

As shown in FIG. 5, the private area 1401 includes one or more information containers 1501. Each information container 1501 corresponds to a use-condition-accompanied area and, in each of the following embodiments, it is an area where to store information to be managed under the same available conditions. Each information container 1501 has a management information area 1502 in which available conditions are set and a data area 1503 for storing storage information. The manner of division of each information container 1501 is arbitrary. An expiration deadline area 1504, a number-of-allowable-times-of-use area 1504, etc. are defined in the management information area 1502.

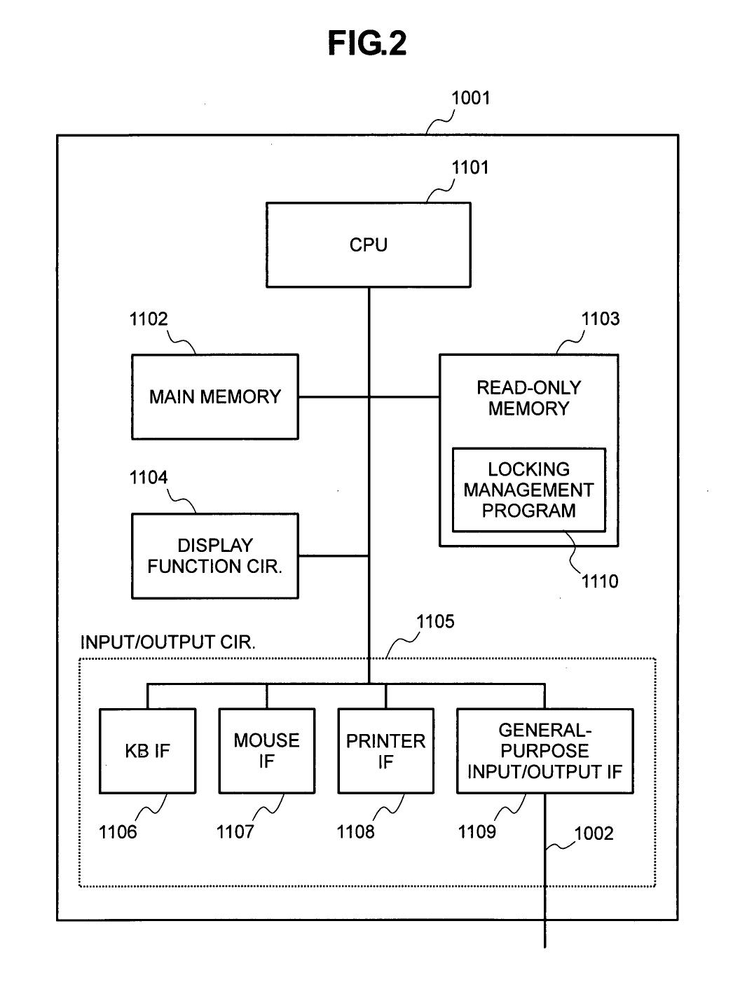

FIG. 2 illustrates the configuration of the terminal 1001. In the terminal 1001, a CPU 1101, a main memory 1102, a read-only memory 1103, a display function circuit 1104, and an input/output circuit 1105 are connected to each other by an internal signal line such as a bus. The input/output circuit 1105 includes a keyboard interface (interface will be abbreviated as IF) 1106, a mouse IF 1107, a printer IF 1108, a general-purpose input/output IF 1109, etc. The general-purpose input/output IF 1109 enables use of the general-purpose input/output bus 1002 to which the external storage device 1005 or the reader/writer 1006 is to be connected.

Programs such as a locking management program 1110 and an operating system (not shown; hereinafter abbreviated as OS) are stored in the read-only memory 1103. A “process” for realizing a piece of processing (described in each of the following embodiments) of the terminal 1001 is constructed in the terminal 1001 by the CPU 1101's running these programs. However, for convenience, the following description will be made as if these programs performed each piece of processing on their own.

An access management section is realized by cooperation between the locking management program 1110 and the operating system. Storing the locking management program 1110 in the read-only memory 1103 makes it difficult for a user to make illegal alterations. This configuration makes it possible to increase the level of safety because illegal access to the management information stored in the external storage device 1005 or the memory card 1007 is made difficult.

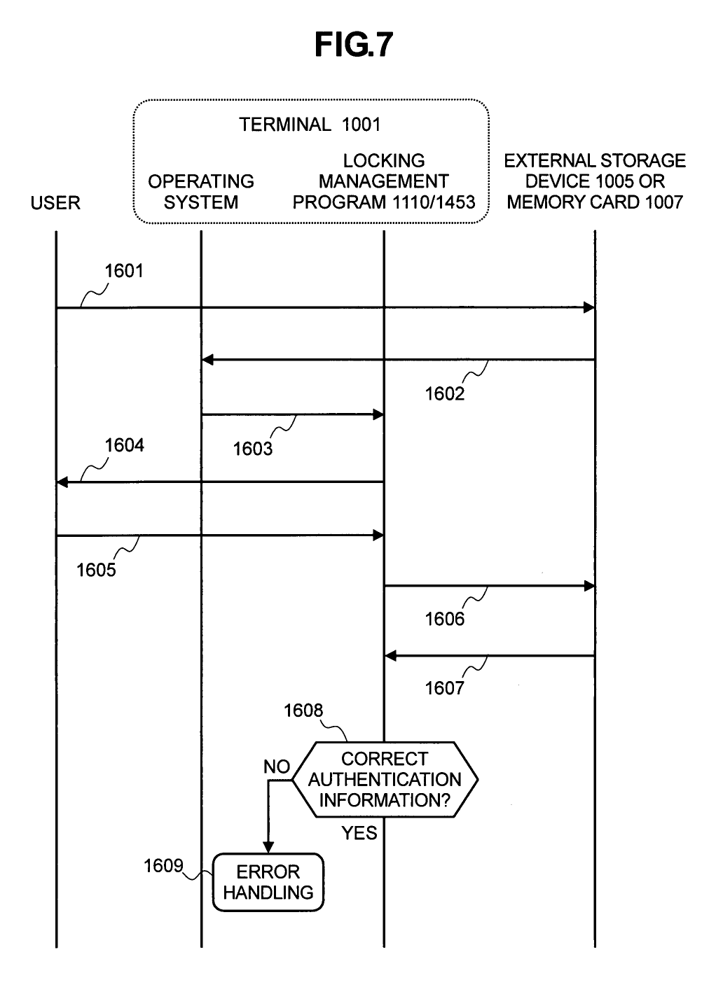

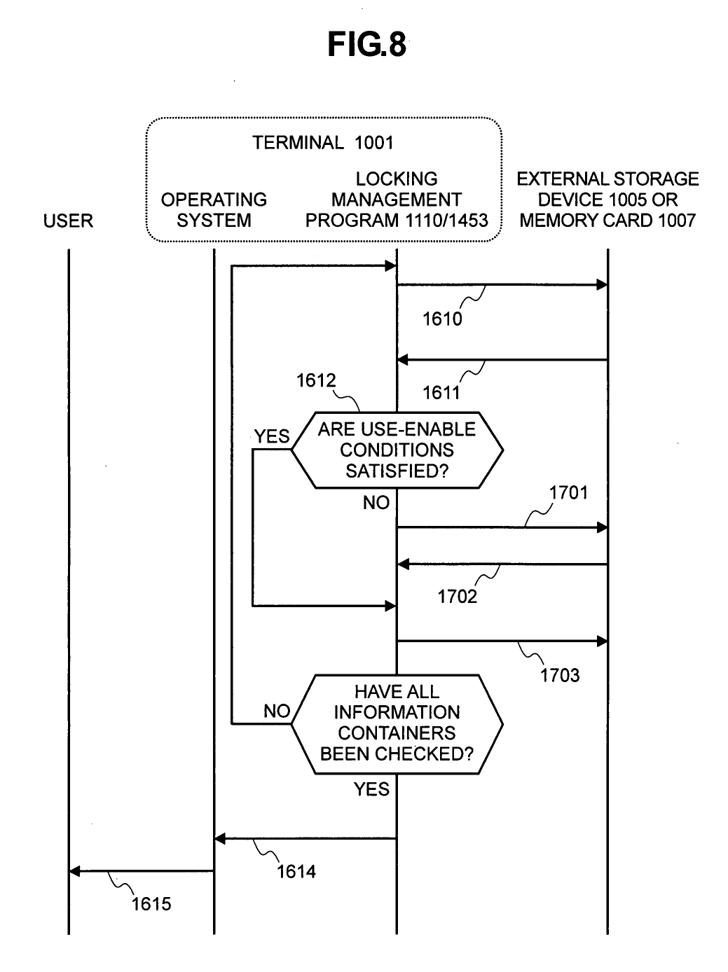

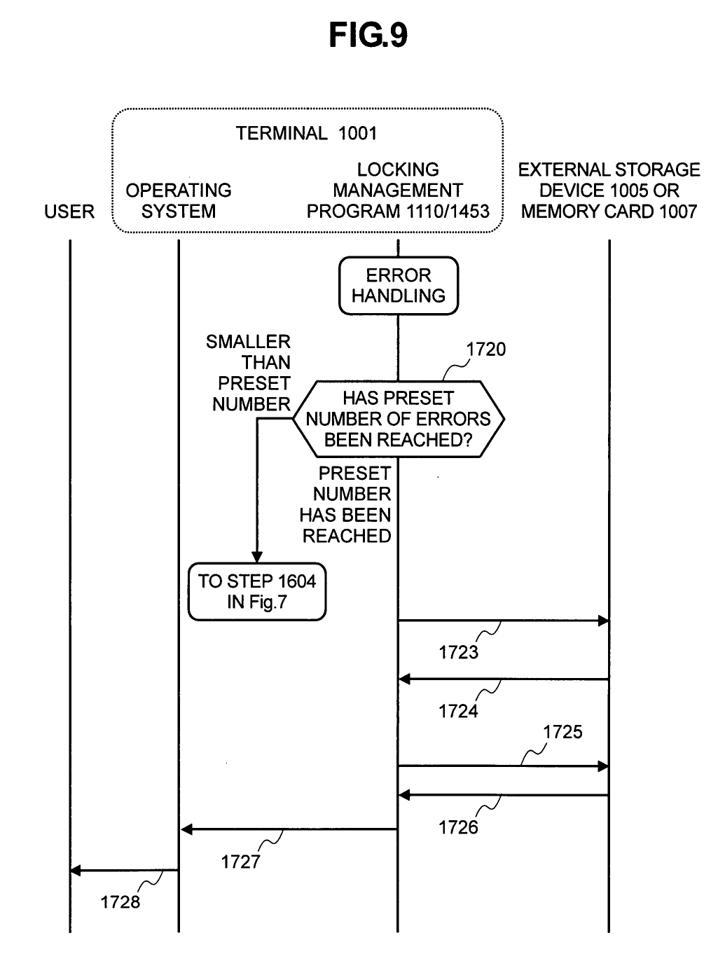

A flow of operation that is performed after the external storage device 1005 or the memory card 1007 being in a locked state is inserted into the terminal 1001 or the reader/writer 1006 will be described below with reference to FIGS. 7-9.

A user connects the external storage device 1005 or the memory card 1007 to the general-purpose input/output bus 1002 of the terminal 1001 (step 1601).

The OS detects, via the general-purpose input/output IF 1109, that the external storage device 1005 or the memory card 1007 has been connected to the general-purpose input/output bus 1002 (step 1602).

In response, the OS instructs the locking management program 1110 to start activation processing (step 1603).

The locking management program 1110 requests the user to input authentication information which is necessary for unlocking the private area 1401 (step 1604).

In response, the user inputs authentication information (step 1605). For example, the authentication information is a password that the user inputs through a keyboard. However, the authentication information is not limited to it and may be biometric information such as a finger vein pattern which is obtained through a reading device (not shown).

The locking management program 1110 sends an unlocking command 1403 with the input authentication information to the external storage device 1005 or the memory card 1007 (step 1606). Before sending the unlocking command, the locking management program 1110 may perform part of processing to be performed on the authentication information.

Receiving the unlocking command, the control section 1003 or 1202 of the external storage device 1005 or the memory card 1007 verifies the authentication information. If judging that the authentication information is legitimate, the control section 1003 or 1202 unlocks the private area 1401. If judging that the authentication information is not legitimate, the control section 1003 or 1202 leaves the private area 1401 in the locked state. And the control section 1003 or 1202 returns the verification result to the locking management program 1110 as a response (step 1607).

At a judgment step 1608, it is judged whether or not unlocking processing has been performed.

If unlocking processing has not been performed and the locked state is maintained, error handling (step 1609) is performed.

If unlocking processing has been performed, since the external storage device 1005 or the memory card 1007 has become usable, the locking management program 1110 instructs the external storage device 1005 or the memory card 1007 to read management information from one information container 1501 of the private area 1401 (step 1610 in FIG. 8) and receives the management information (step 1611).

The locking management program 1110 checks the available conditions contained in the management information and judges whether or not the use, by the user, of the storage information stored in the data area 1503 of the information container 1501 is legitimate (step 1612 in FIG. 8).

If the available conditions are not satisfied (step 1612: no), the locking management program 1110 instructs the external storage device 1005 or the memory card 1007 to erase the storage information of the information container 1501 (step 1701). The control section 1003 or 1202 of the external storage device 1005 or the memory card 1007 reports a processing result to the locking management program 1110 (step 1702).

If the available conditions are satisfied (step 1612: yes) and if they include the number of allowable times of use, the locking management program 1110 updates it to a remaining number of allowable times of use (step 1703).

The locking management program 1110 judges whether all the information containers 1501 have been processed (step 1704). If not all the information containers 1501 have been processed, the process returns to step 1610 to start processing another information container 1501.

Various available conditions can be set by the manager, examples of which are an expiration deadline and the number of allowable times of use. Only one available condition may be employed. Or plural available conditions may be combined arbitrarily.

For example, a setting “effective until 18:30 of Dec. 31, 2006” is possible. Another condition such as “the number of allowable times of use is five” may be added. Where plural available conditions are set, the operation procedure is formulated so that the storage information is made usable if all of the plural conditions are satisfied.

The manager writes available conditions to the management information areas 1502 in advance for each information container 1501.

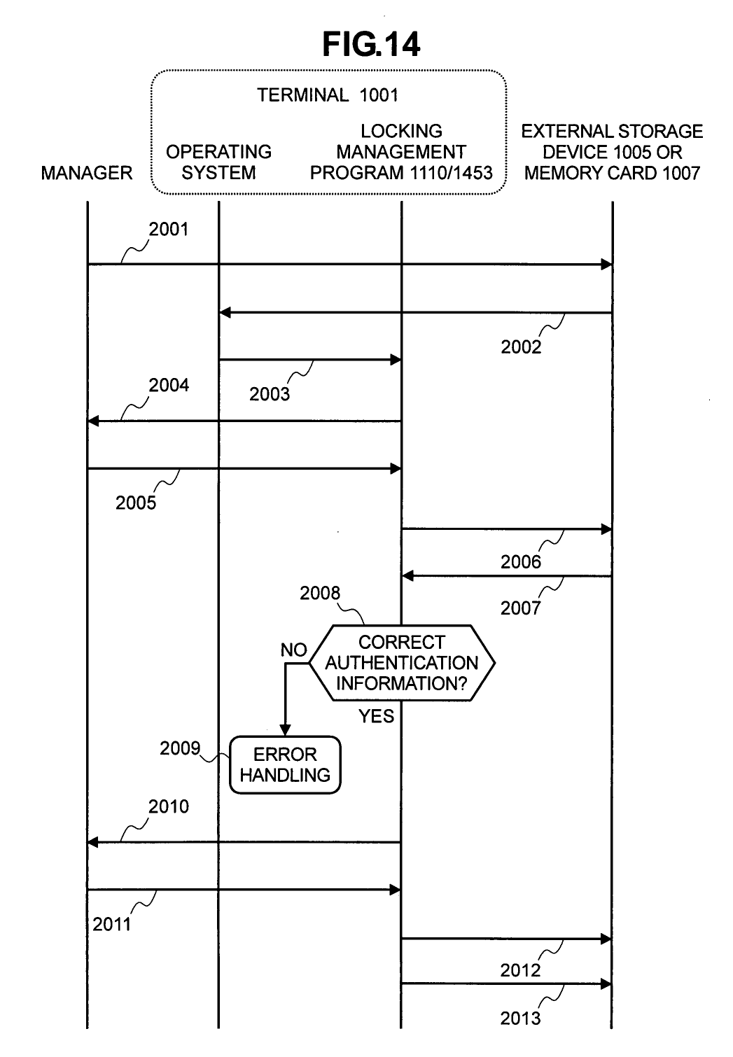

An exemplary method by which the manager sets management information for each information container 1501 will be described later with reference to FIG. 14 (fourth embodiment) If all judgments have been made and it has been found that the available conditions of all the information containers 1501 are satisfied or information containers 1501 whose available conditions are not satisfied have been subjected to the above-mentioned erasure processing, the locking management program 1110 reports, to the OS, that information containers 1501 whose available conditions are satisfied have become usable (step 1614).

If use statuses such as the numbers of allowable times of use have also been checked at step 1612, updated (i.e., latest) values are written to the management information areas 1502.

Only after receiving the above report, the OS informs the user that the external storage device 1005 or the memory card 1007 has become usable and a state that a next manipulation can be received has been established (step 1615).

That is, the user is forced to stand by and cannot use the external storage device 1005 or the memory card 1007 during a period from the insertion of the external storage device 1005 or the memory card 1007 (step 1601) to the notification from the OS (step 1615). The last two steps (i.e., the reporting to the OS and the notification from the OS) are not indispensable.

If there is an information container 1501 whose storage information has been erased, information indicating that information container 1501 may be presented to the user at step 1615. Alternatively, the OS may refrain from informing the user of the fact that there is an information container 1501 whose storage information has been erased.

In error handling (step 1609, 1917, or 2009), the following processing shown in FIG. 9 is performed.

It is judged whether the number of times of occurrence of an authentication information input error has reached a preset number (step 1720).

If it is smaller than the preset number (step 1720: “smaller than the preset number”), the process returns to step 1604 in FIG. 7, where the locking management program 1110 again prompts the user to input correct authentication information. If it has reached the preset number (step 1720: “the preset number is reached”), the locking management program 1110 judges that the current user is not a legitimate one and erases the storage information of all the information containers 1501 of the private area 1401 according to the following procedure.

First, the locking management program 1110 sends a manager unlocking command (denoted by 1405 in FIG. 6) to the external storage device 1005 or the memory card 1007 as an instruction to unlock the private area 1401 (step 1723). Authentication information is not indispensable for the manager unlocking command which is sent at step 1723.

After receiving an unlocking report (step 1724), the locking management program 1110 issues an instruction to erase the storage information of all the information containers 1501 of the private area 1401 (step 1725).

The control section 1003 or 1202 of the external storage device 1005 or the memory card 1007 erases the contents of all the information containers 1501 and sends a report (step 1726).

The locking management program 1110 informs the OS of the report (step 1727). Since the storage information of the information containers 1501 has been erased, the locking management program 1110 may either issue or not issue a manager locking command corresponding to step 1723.

The OS may inform the user of the fact that the storage information has been erased (step 1728).

As is understood from the above process, information leakage can be prevented more reliably by detecting use by a non-legitimate user and erasing the contents of the information containers 1501.

### Second Embodiment

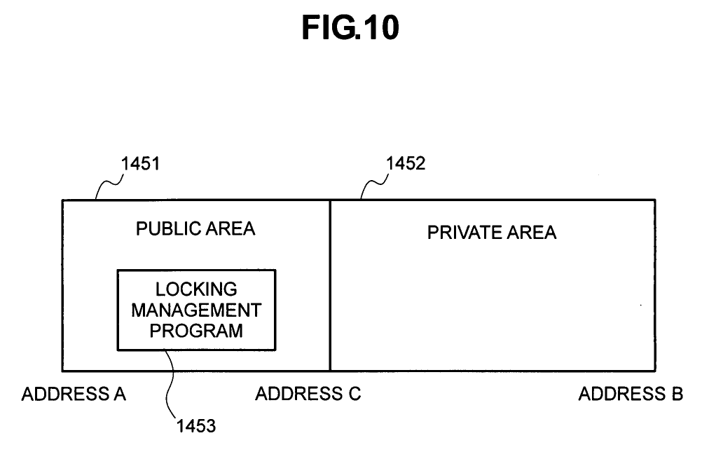

An external storage device according to a second embodiment of the invention will be described below with reference to FIGS. 10-12.

FIG. 10 shows a method for managing the storage area of the nonvolatile storage element 1004 or 1203 of the external storage device 1005 or the memory card 1007 in such a manner that it is divided into two areas. For example, the storage area from address A to address B of the nonvolatile storage element 1004 or 1203 is divided at a halfway address C. The first half (address A to address C) is made a public area 1451 for which no access control is performed and which can therefore be used anytime by anyone, and the second half (address C to address B) is made a private area 1452 which is similar to the private area 1401 of the first embodiment.

A locking management program 1453 which is equivalent to the locking management program 1110 of the first embodiment is stored in the public area 1451 in advance. Since the locking management program 1453 is stored in the public area 1451, it is not necessary to store the locking management program 1110 in the read-only memory 1103 of the terminal 1001 in advance (the OS is stored in the read-only memory 1103 as in the first embodiment).

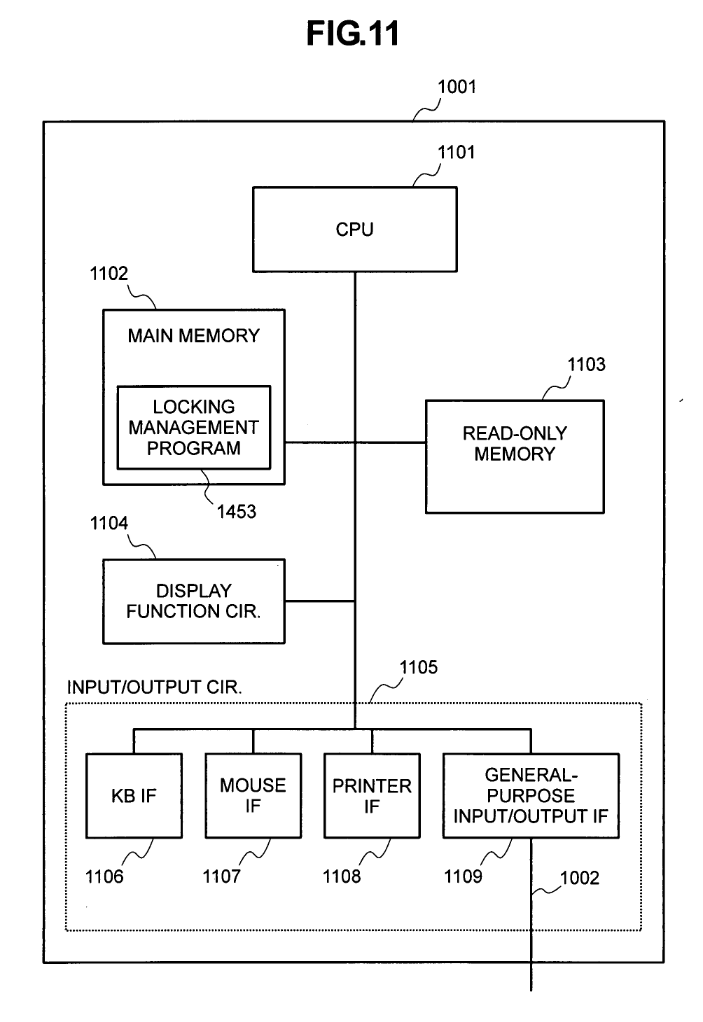

FIG. 11 shows the above-described setting of the terminal 1001. The locking management program 1110 which is stored in the read-only memory 1103 in the first embodiment is not necessary. Instead, when the external storage device 1005 or the memory card 1007 is attached to the terminal 1001, the locking management program 1453 is read from the public area 1451 and stored in the main memory 1102. Then, a process similar to the process of the first embodiment can be executed when the locking management program 1453 is activated by automatic execution or activated explicitly by the user.

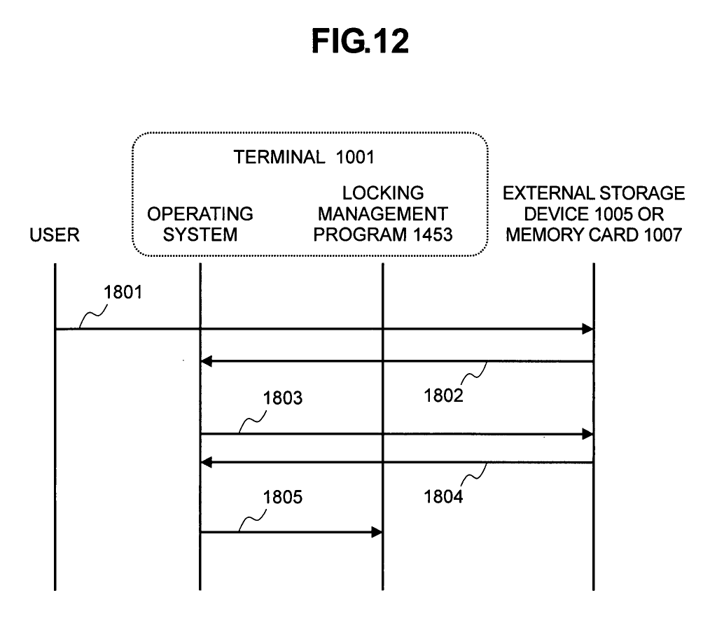

FIG. 12 shows how the above-mentioned automatic execution is done.

The user connects the external storage device 1005 or the memory card 1007 to the terminal 1001 (step 1801). The OS detects insertion information. At this time, if an automatic execution function is effective in the OS, the OS issues an instruction to read the locking management program 1453 which is stored in the public area 1451 (step 1803).

The OS stores the locking management program 1453 in the main memory 1102 (step 1804). After being stored in the main memory 1102, the locking management program 1453 is activated in the same manner as at step 1603 by the function of the OS or an explicit instruction from the user (step 1805). The subsequent process is the same as in the first embodiment.

In this embodiment, it is desirable that prior to step 1801 the OS performs user authentication processing to prevent illegal access for, for example, rewriting of the management information by a non-legitimate user.

### Third Embodiment

A third embodiment is directed to a case that the manner of use of a locking command (see FIG. 6) is simplified.

This embodiment can be applied to a case that whether the user is legitimate can be checked by using the external storage device 1005 or the memory card 1007 when the terminal 1001 is activated. For example, this embodiment can be applied to a case that the memory card 1007 has the configuration of FIG. 4 and that whether the user is legitimate can be verified by using the IC card chip 1303 incorporated in the memory card 1007 according to the public key base technology when the terminal 1001 is activated.

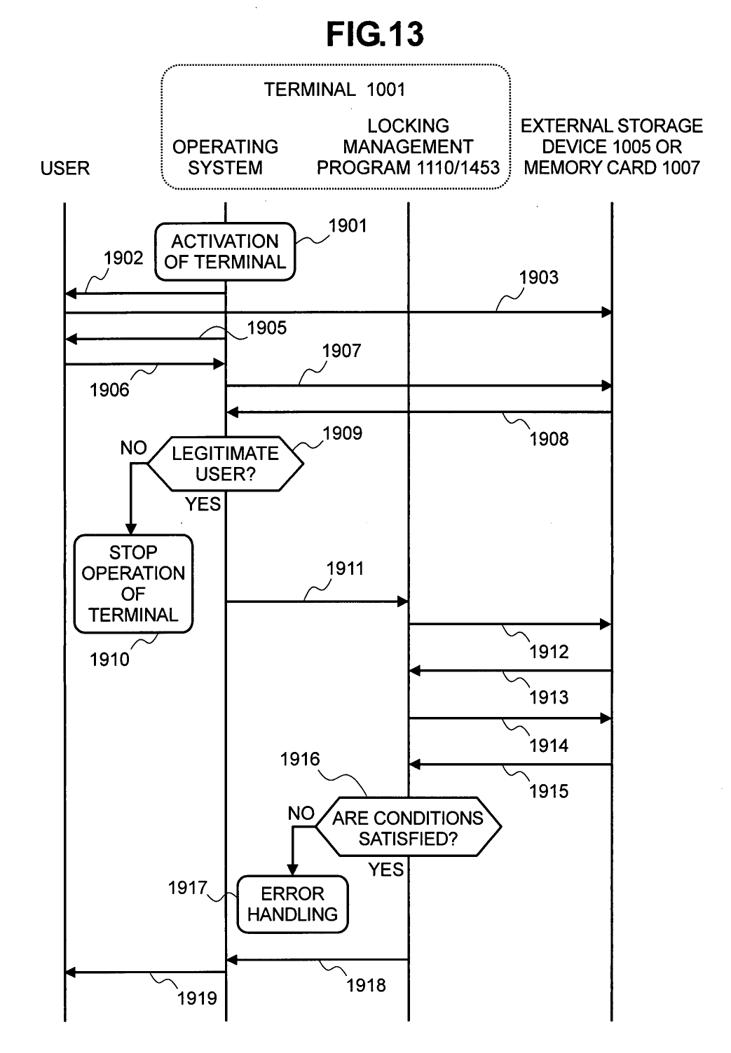

A process flow of this embodiment will be described below with reference to FIG. 13.

The OS starts terminal activation processing (step 1901), and requests the user to make a log-in input (step 1902).

The user inserts the memory card 1007 for the purpose of authorization (step 1903).

Then, the OS requests the user to input authentication information for the purpose of user authentication (step 1905).

The OS stores authentication information that has been input by the user (step 1906) and sends it to the memory card 1007 (step 1907).

The IC card chip 1303 of the memory card 1007 judges, on the basis of the user-input authentication information, whether or not the user is a registered, legitimate one and returns a response to the OS (step 1908).

If the response indicates that the user is not a legitimate one, the OS performs processing 1910 of stopping the operation of the terminal 1001. The process is then finished.

If the user is a legitimate one, the OS performs processing 1911 of activating the locking management program 1110 to unlock the memory card 1007. At this time, the OS passes the user's stored authentication information to the locking management program 1110 and the locking management program 1110 sends an unlocking command 1403 with the authentication information to the memory card 1007 (step 1912). As in the case of the first embodiment, part of the authentication information to be sent may have already been processed.

Since the locking management program 1110 receives the authentication information from the OS and stores it, it is not necessary to request the user to input authentication information again. This is because whether the user is a legitimate one has already been judged at step 1909 when the terminal 1001 was activated.

The subsequent process is the same as in the first embodiment.

The above three embodiments are not limited to the case that only one set of a locking command 1402 and an unlocking command 1403 are provided. As shown in FIG. 6, a manager locking command 1404 and a manager unlocking command 1405 may also be provided. Providing commands that are dedicated to the manager separately from the ordinary commands allows the manager to give an instruction to unlock or lock the memory card 1007 using the manager locking command 1404 or the manager unlocking command 1405 even in the case where the ordinary command cannot be used for a certain reason, for example, in the case where the user forgets his or her authentication information or the user's authentication information is unknown because of his or her absence. Also in this case, it is desirable to set authentication information to prevent limitless unlocking by all managers who are supposed to deal with the system.

### Fourth Embodiment

An exemplary method by which the manager sets management information for each information container 1501 will be described below with reference to FIG. 14.

The manager connects the external storage device 1005 or the memory card 1007 to the general-purpose input/output bus 1002 of the terminal 1001 (step 2001).

When the OS detects, via the general-purpose input/output IF 1109, that the external storage device 1005 or the memory card 1007 has been connected to the general-purpose input/output bus 1002 (step 2002), the OS instructs the locking management program 1110 to start activation processing (step 2003).

The locking management program 1110 requests the manager to input authentication information to unlock the private area 1401 (step 2004).

The manager informs the locking management program 1110 that the manager is going to do writing to the management information areas 1502 and inputs manager authentication information (step 2005).

The locking management program 1110 sends a manager unlocking command 1405 with the input authentication information to the external storage device 1005 or the memory card 1007 (step 2006).

When receiving the unlocking command, the control section 1003 or 1202 of the external storage device 1005 or the memory card 1007 verifies the authentication information. If judging that the manager is a legitimate one, the control section 1003 or 1202 unlocks the private area 1401 and enables writing to and update of the management information areas 1502 of the information containers 1501. If judging that the manager is not a legitimate one, the control section 1003 or 1202 maintains the locked state and returns the check result to the locking management program 1110 as a response (step 2007).

At a judgment step 2008, the locking management program 1110 judges whether the manager was judged as a legitimate one.

If the manager was not judged as a legitimate one and the locked state is maintained, error handling is performed (step 2009).

If the manager was judged as a legitimate one and unlocking was effected, since writing to or update of the management information areas 1502 has been enabled, the locking management program 1110 prompts the manager to do writing to or update of the management information area 1502 for each information container 1501 (step 2010).

The manager inputs management information for an information container 1501 to be set (step 2011), and the locking management program 1110 does writing to or update of the management information area 1502 of the subject information container 1501 of the external storage device 1005 or the memory card 1007 (step 2012).

When the locking management program 1110 has completed the writing to or update of the management information area 1502 of the subject information container 1501 of the private area 1401, the locking management program 1110 performs locking processing using a manager locking command 1404 (step 2013).

Information to be used for user authentication at step 1607 by the control section 1003 or 1202 is stored in the control section 1003 or 1202 as is done in the above process after the manager authentication.

The above-described four embodiments or part of them can be practiced in combination as appropriate.

As described above, in the external storage device 1005 or the memory card 1007 according to each of the above embodiments, the locking management program 1110 or 1453 can manage the private area 1401 or 1452 safely. Therefore, an external storage device 1005 or a memory card 1007 can be constructed which assures safety of a user and is easy to use.

Therefore, according to the embodiments, the usability of a user is increased even in an environment in which a communication line cannot be secured. Furthermore, even if the external storage device 1005 or the memory card 1007 is stolen or lost, the stored contents are erased upon occurrence of an illegal access manipulation by a third party. The risk of information leakage is thus very low.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. An external storage device access system having an external storage device and a terminal apparatus, wherein
the external storage device comprises a storage element in which an access-controlled area is set which is access-controlled on the basis of authentication information and a control section for access-controlling the storage element;
the terminal apparatus comprises an input/output interface and an access management section for accessing the external storage device; and
when the external storage device is connected to the input/output interface,
the control section is activated in such a state that it refuses access to the access-controlled area;
after detection of the connection of the external storage device to the input/output interface, the access management section of the terminal apparatus sends, to the control section, a request, including authentication information of a user of the terminal apparatus, for permission of user access to the access-controlled area;
the control section of the external storage device performs verification of the user authentication information received from the terminal apparatus;
if the verification succeeds, the control section sends, to the terminal apparatus, a notice of permission of user access to storage information that is stored in the access-controlled area; and
if the verification fails, the control section erases the storage information stored in the access-controlled area.

2. The external storage device access system according to claim 1, wherein
the control section sends a notice of the failure of the verification to the access management section of the terminal apparatus;
when receiving the notice of the failure of the verification, the access management section sends, to the control section, an instruction to erase the storage information stored in the access-controlled area; and
when receiving the instruction to erase the storage information, the control section erases the storage information stored in the access-controlled area.

3. The external storage device access system according to claim 1, wherein
the access-controlled area comprises one or more use-condition-accompanied areas for which use conditions are set, respectively;
each of the use-condition-accompanied areas comprises a management information area for storing the use condition and a data area for storing the storage information;
if the verification of the user authentication information succeeds, the control section makes a transition to a state that it permits reading of the use conditions stored in the management information areas and can permit access to the storage information stored in the data areas;
when receiving, from the control section, the user access permission notice which is sent in response to the user access permission request, the access management section of the terminal apparatus sends, to the control section, an instruction to read the use conditions stored in the management information areas of the one or more use-condition-accompanied areas, checks whether or not to permit user access to the individual use-condition-accompanied areas on the basis of the read-out use conditions received form the control section, sends, to the control section, an instruction to erase the storage information stored in the data area of a use-condition-accompanied area for which user access has been refused, and sends, to the user, after erasure of the storage information, a notice of permission of access to the storage information stored in the data area of a use-condition-accompanied area for which user access has been permitted;
when receiving the use conditions reading instruction from the access management section of the terminal apparatus, the control section of the external storage device reads the use conditions stored in the management information areas and sends them to the terminal apparatus; and
when receiving, from the access management section of the terminal apparatus, the instruction to erase the storage information stored in the data area of the use-condition-accompanied area for which user access has been refused, the control section erases the storage information.

4. The external storage device access system according to claim 3, wherein each of the use conditions is an expiration deadline and/or the number of allowable times of use.

5. The external storage device access system according to claim 4, wherein if each of the use conditions includes the number of allowable times of use and if user access to the data area of a use-condition-accompanied area is permitted, the access management section writes a use condition in which the number of allowable times of use has been updated to the management information area of the use-condition-accompanied area before sending a notice of permission of access to the storage information to the user.

6. The external storage device access system according to claim 3, wherein
the external storage device further comprises a non-access-controlled area which is not access-controlled by the control section on the basis of user authentication information;
a program for implementation of the access management section of the terminal apparatus is stored in the non-access-controlled area; and
when the external storage device is connected to the input/output interface and the terminal apparatus is activated, the terminal apparatus reads the program by accessing the non-access-controlled area, runs the program, and thereby implements the access management section in the terminal apparatus.

7. The external storage device access system according to claim 6, wherein
when the external storage device is connected to the input/output interface and the terminal apparatus is activated, the terminal apparatus performs authentication of the user of the terminal apparatus before reading the program by accessing the non-access-controlled area; and
if the user authentication succeeds, the terminal apparatus reads the program.

8. The external storage device access system according to claim 1, wherein
the external storage device further comprises a user authentication processing section for authenticating a user;
when the external storage device is connected to the input/output interface of the terminal apparatus and the terminal apparatus is activated, the access management section of the terminal apparatus stores input user authentication information and sends it to the user authentication processing section of the external storage device;
the user authentication processing section performs processing of authenticating the user using the received user authentication information and sends an authentication result to the access management section;
if the authentication result of the user authentication processing section indicates that the user is legitimate, the access management section uses the stored user authentication information as authentication information of the user of the terminal apparatus to be included in the request for permission of user access to the access-controlled area; and
if the authentication result indicates that the user is not legitimate, the access management section stops operation of the terminal apparatus.

9. The external storage device access system according to claim 3, wherein
when the external storage device is connected to the input/output interface of the terminal apparatus and the terminal apparatus is activated, if connection, to the input/output interface, of the external storage device being in a state that access to the access-controlled area is refused is detected,
the access management section sends, to the control section, a request, including authentication information of a manager of the external storage device, for permission of manager access to the access-controlled area;
the control section performs verification of the manager authentication information received from the terminal apparatus, and, if the verification succeeds, sends, to the access management section, a notice of permission of manager access to the management information areas of the use-condition-accompanied areas;
the access management section writes or update a use condition to or in a management information area by manager access, and sends, to the control section, a notice of completion of the manager access after completion of the manager access; and
when receiving the manager access completion notice, the control section makes a transition to a state that it refuses access to the access-controlled area.

10. An external storage device which can be connected to a terminal apparatus and accessed by the terminal apparatus, comprising:
a storage element in which an access-controlled area is set which is access-controlled on the basis of authentication information; and
a control section for access-controlling the access-controlled area, the external storage device further characterized in that:
when the external storage device is connected to the terminal apparatus,
the control section is activated in such a state that it refuses access to the access-controlled area, and performs verification of user authentication information received from the terminal apparatus;
if the verification succeeds, the control section sends, to the terminal apparatus, a notice of permission of user access to storage information that is stored in the access-controlled area; and
if the verification fails, the control section erases the storage information stored in the access-controlled area.

11. The external storage device according to claim 10, wherein
the control section sends a notice of the failure of the verification to the terminal apparatus; and
when receiving an instruction to erase the storage information from the terminal apparatus, the control section erases the storage information stored in the access-controlled area.

12. The external storage device according to claim 10, wherein
the access-controlled area comprises one or more use-condition-accompanied areas for which use conditions are set, respectively;
each of the use-condition-accompanied areas comprises a management information area for storing the use condition and a data area for storing the storage information;
if the verification of the user authentication information succeeds, the control section makes a transition to a state that it permits reading of the use conditions stored in the management information areas and can permit access to the storage information stored in the data areas;
when receiving, from the terminal apparatus, an instruction to read one of the use conditions, the control section reads the one use condition stored in the management information area and sends it to the terminal apparatus; and
when receiving, from the terminal apparatus, an instruction to erase the storage information stored in the data area of one of the use-condition-accompanied area, the control section erases the storage information.
